(19) United States
(12) Patent Application Publication
(10) Pub. No.: US 2011/0192370 A1
(43) Pub. Date: Aug. 11, 2011

(54) Positive-Displacement Engine

(76) Inventor: Xiping Wang, Beijing (CN)

(21) Appl. No.: 11/794,710

(22) PCT Filed: Dec. 28, 2005
(86) PCT No.: PCT/CN05/02333

§ 371 Date: Feb. 26, 2008

(30) Foreign Application Priority Data
Jan. 4, 2005 (CN) 200510000103.9

(51) Int. Cl. F02F 3/28

(52) U.S. Cl. 123/193.6

(57) ABSTRACT

The most difference for one kind of the positive-displacement engine from capacity-invariable engine is, the CVE has double pistons interlinked mutually in every cylinder. Inner piston connects with the piston pin by the connecting rod. Outer piston with a ring sits on inner piston supported by the spring. The characteristic of this engine is: Every stroke volume changes diversity. In exhaust stroke, outer piston gets to the tiptop of the cylinder, waste gas almost discharges (exhaust ratio can be to 95%˜98% in theory), compression ratio is improved (≧12); In intake stroke, outer piston continues moving by the inertia at the end of the intake stroke, the air intake volume increases. So it realizes the automatic supercharging and the fuel efficiency and emission have improved. Since outer piston has the effect of storing energy, the peak pressure and the speed of the pressure raising have been reduced. Thereby, the force on the structure is lower down and the engine weight could be lightened, the smoothness of operation is also improved. Also the peak pressure shifts to right, the torque output increases and engine efficiency is improved. There are great performance improvements of this positive-displacement engine then capacity-invariable engine.

### TECHNICAL FIELD

This invent concern of internal combustion engine, especially 4_stroke igniting engine (Such as: petrolic), it also apply for diesel fuel or 2-stroke engine.

### BACKGROUND OF THE ART

Internal combustion engine especially 4-stroke petrol engine (including other fuels working like this) is a foremost power supplier in nowadays, it usually used in lightweight automotive extensively.

After developing for more than hundred years, at present, the 4-stroke petrol engine already is being perfected, new technique appears unceasingly, and it's applications also gradually appearing to be broader. But so far all engines can be called capacitance-invariable engine, that the travel volume of the four stroke is completely identical, which makes this kind of engine with a little inherent contradiction have no way to solve completely right away.

Firstly, Compression ratio and exhaust residuals: To avoid deflagration phenomenon happened to the gasoline mixture, the compression ratio is controlled in 8^{˜}11 at present, That is to make the combustion volume on top of the piston being about 1/10 of the cylinder capacity, but it is exactly the waste residual capacity end of the exhaust stroke. At the end of the intake stroke, the pressure is about Pa=0.07^{˜}0.09 MP, temperature is Ta≈400° K; While at the end of the exhaust stroke, the pressure is about P_{b}≈0.11 MP, temperature is T_{b}≈1000° K; So the ratio value of residual volume is about K≈0.07. It is good affections to diminish K value for improving engine power, efficiency and reducing pollution of the car emission. Using the boost-technology to be able to improve K value, but pressurizing is complicated and will increase the cost of engine.

Secondly, The contradiction between improve the maximal gasses pressure Pm of the operating cycle with smooth-going, efficiency:

FIG. 1 is a schematic diagram illustrating work of the 4-stroke petrol engine, the engine work based on that moment of torsion outputs of the crank, So “moment of torsion-corner” curve (M-α) can express the engine working more accurately comparing with “pressure-volume” curve (P-V). FIG. 2 is a diagram showing the force distributing of the crank-guide.

The moment when the crank arm turn away α can be express as follow:

M=F*R(sin α+cos α*tan β)

M=F*R′

In the formula:
F—The total thrust of piston from the burn gasses, F=P*S;
P—the gas pressure in the cylinder;
S—the area of the top of the piston;
R—the radius of the crank;
R′—the effective radius; R′=R(sin α+cos α*tan β); β=sin⁻¹(R/L sin α);
L—length of the connecting rod;

According to the above formula, we can calculated the “torque-angle” curve roughly. As the curve (M-α) in FIG. 1, it is clearly that the area M-α curve surrounded express the work more accurately, which a single cylinder made in the whole work cycle.

A common (capacitance-invariable) engine as requirements of the maximal gas pressure Pm is in the crank angle α=12^{˜}15° (point d in FIG. 1).

Now: Md≈Fm*R′=Pm*S*R′, It is not the maximal output torque Mm, that means engine assemblies (piston pin, connecting rod, crankshaft, camshaft and the body) support almost the press causing by the Pm. As the pressure Pm boosts very quickly, the impact effect to the mechanical assemblies is more visible. This calls for using the structure strong enough, so the farther engine lightweight is limited.

From FIG. 1, the peak value of torsion (Mm) of the general (capacitance-invariable) engine is not in the same point with maximal born gas pressure (Pm) in cylinder. so, the general curve of the “pressure-volume” (P-V) curve is not the best curve expressing engine work.

Thirdly, Complex pistons structures, poor working conditions, shorter working life: All engine piston working conditions are extremely bad in present. A high temperature, high pressure gas in each work cycle. The gas pressure drive the crank working together with the cylinder sealed and smaller inertia is to be required. These interrelated requirements make the piston using light metal materials (such as aluminum alloy) almost without exception, So it has a larger deformation under high pressure, high heat conditions. The distribution of the piston mass is very uneven due to the supporting structure of the piston pin, which increase the deformation caused by the temperature difference. In order to reduce these affections will only to make the piston shape becomes very complex, so processing is not easy. Expect that, an opposite lateral force make the piston press down to the cylinder when the piston working or being compressed in connecting rod-crank mechanism. So that the pistons have uneven wear, which affect the life. Although motor-scope has never stopped improving these problems over the years, structure, materials, processing and other aspects of many studies, this issue has not been completely resolved or basically solved.

### SUMMARY

To this end, the purpose of the invention is to provide a new design of the positive-displacement engine (also be named capacitance-variable engine, abridge: CVE), to solve above problems.

The purpose of this invention is to achieve: The capacitance-variable engine consist of cylinder, cylinder head and the intake and exhaust valve system, spark plug, piston, connecting rod, crankshaft and so on. The biggest difference from general engine is: the piston consists of the outer piston and inner piston, Piston rings is installed on outer piston; a pin hole is in inner piston, and with the connecting rod matched. the inner diameter of the outer piston is slightly bigger than the cylindrical diameter of the inner piston. That is the inner piston installed sliding in the outer piston. Elastic components on the top inner wall of the outer side, which can be supported with the inner piston, so there is a compressible interspaces between the top inner face of the outer piston and the top of the inner piston.

A ring groove is cut in the bottom of the inner bore for the outer piston, with a elastic retainer ring on the groove. The inner diameter of the ring is smaller than the outer diameter of the inner piston, so that the inner piston can not be away from the inner bore of the outer piston.

The elastic components can be one or more of helical spring, bowl spring, conical spring or nor-isometric spring. Or it could be no less than two sets of mutual cooperation of the spring group, with the inner short spring stiffer than the outer long spring. The outer spring is higher than the movable (compressed) interspaces height after the inner and outer pistons are installed well. So that there are would not free gap between the inner piston, outer piston, spring and spring retainer when the piston group are assembled.

The outer piston has no pin holes with a radically symmetric structure, which eliminates temperature deformation caused by the uneven mass distribution. The inner or outer surface can be a round circle, thereby avoid the complex oval face processing. To make the oil spraying from the small end hole of the connecting rod cooled fully the outer piston, A bridging core with protuberances is on its top central wall and a flow-guiding cambered surface adjacent.

Since the inner piston does not touch the burn gas, it's top surface can be not to seal. That makes inner piston design can consider structure stiffness and the manufacturability processing sufficiently, there are some gusset plates connected the side of the two piston holes' seat, also between the side face and the inner face of the inner piston, which depresses the deformation of the inner piston remarkably. And since the inner piston does not touch the high temperature gas, also with the sufficient cooling, the inner piston temperature cannot rise higher, which may make the pin holes' diameter be smaller than the pin's diameter a bit thereby, so the pin hole and the piston pin can go together tightly, avoid wearing of the pin holes, this can make the piston life longer.

To make a back-flow passage for oil from the outer piston ring, there is a leading oil groove on the top of outer face of the inner piston, also with a oil-returning hole on the bottom of the groove leading to the inner bore of the inner piston.

To make the spring steady during the period of piston alternating movement, there is a locating hole for the spring on the top of the inner piston, also with a oil-returning hole for the cooling oil on the bottom or the side face of the locating hole, this can make the cooling oil spraying from the small end hole of the connecting rod can reflow the oil tank freely.

It is observed that the CVE has a double-piston structure (with appropriate spring stiffness), which can make the outside space between the top of the outer piston and the cylinder head or distance of travel changed with every working stroke condition:

1) On the top dead position of the compression stroke, the air-fuel mixture being pressured makes the outside piston compress spring, to make the space between the top surface of outer piston and the cylinder head reach the request of combustion conditions (pressure P, temperature T) for presetting compression ratio. This is one of the basis design content of the CVE. (For example, If the compression ratio setting up is ε=10, the air pressure in cylinder is about 1 MP now, combustion chamber volume is about one tenth of the general volume of cylinder);

2) On the end of the exhaust stroke, the pressure is about 0.1 MP, outer piston is far away from inner piston during to the spring force and inertia force, then the space between the top of outer piston and the cylinder head is reduced, and the waste gas reduce significantly.

3) During the intake stroke, outer piston is on the tip top of the cylinder when it is on beginning location (top dead center), and when on terminal location (bottom dead center), the inner piston stops moving, but outer piston continues moving down with the inertia force, the air intake volumes enlarge effectively.

4) In power stroke, when the air-fuel mixture igniting, the pressure increased sharply, outside piston continues moving down a bit withstanding the spring (high stiffness) force, expanding combustion chamber volume thereby, making the firing slowly and making the pressure ascend slowly, with the peak pressure in the curve moves to right. As before description, this would increase the output torque, the effective power and improve the force state of the engine components.

### BRIEF DESCRIPTION OF THE DRAWINGS

FIG. 1 Schematic diagram illustrating acting of engine

FIG. 2 Diagram showing the force distributing on the crank-guide

FIG. 3 Structural schematic diagram of a piston of the CVE (with a front view of the piston on the left hand and a lateral view of the same on the right hand)

FIG. 4 Volumetric change schematic diagram of the CVE

FIG. 5 Structural schematic diagram of outer piston

FIG. 6 Structural schematic diagram of outer piston and valve corresponding of the CVE

FIG. 7 Structural schematic diagram of inner piston of the CVE

FIG. 8 Stiffness and structure diagram of the spring of the CVE

### DETAILED DESCRIPTION

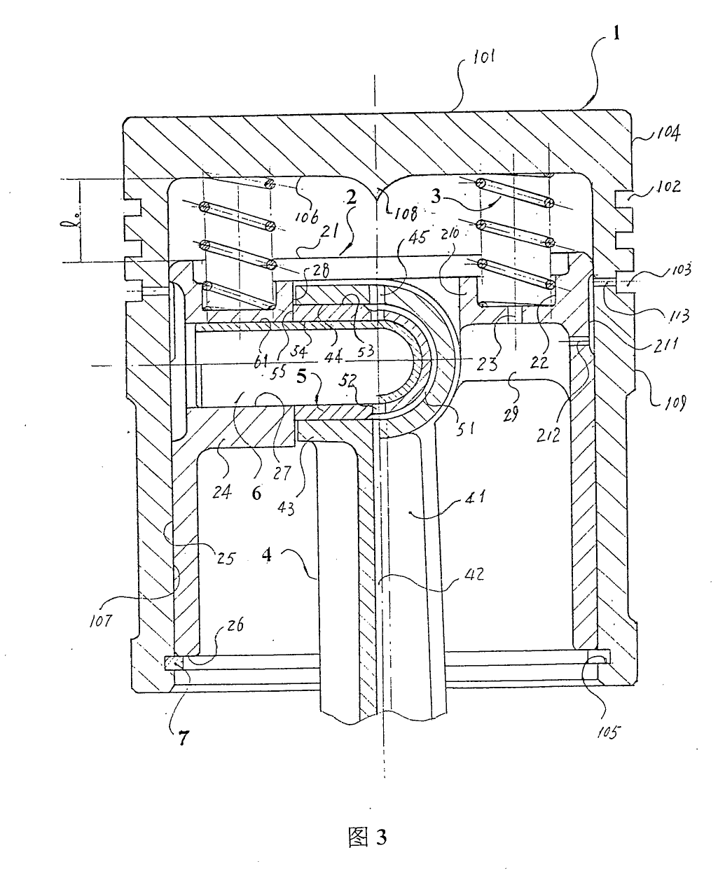

FIG. 3 is a schematic diagram applying of the invention CVE,

The piston of this CVE include of the outer piston 1, inner piston 2 and spring 3. Gas loop groove 102 (for gas ring) and oil ring groove 103 (for oil ring) installed on the top circle face 104 of the outer piston 1. Inner hole 107 of the outer piston is a cylindrical hole, with a retainer ring groove 105 on the bottom, retainer ring 7 located in the groove 105, diameter of the retainer 7 is smaller than the outer diameter 25 of the inner piston 2.

Inner piston 2 installed sliding in the inside hole 107 of outer piston 1. A pin hole's seat 24 is on Inner piston 2, with a piston pin 6 fixed closely in. piston pin 6 covers over the bearing sleeve 5 of the small end hole on the connecting rod 4. Bearing sleeve 5 is pressed tightly in the small end hole 44 on the connecting rod 4, with a oil groove 51 on the bearing sleeve 5 and a oil outlet 43 on the top end of the connecting rod 4. A spring mounting hole 22 is on the top surface 210 of inner piston 2, for fasten the spring.

The tip surface 101 of the outer piston 1 is either a level surface, convex surface or a concave surface such as bowl which can meet the request of the combustion chamber.

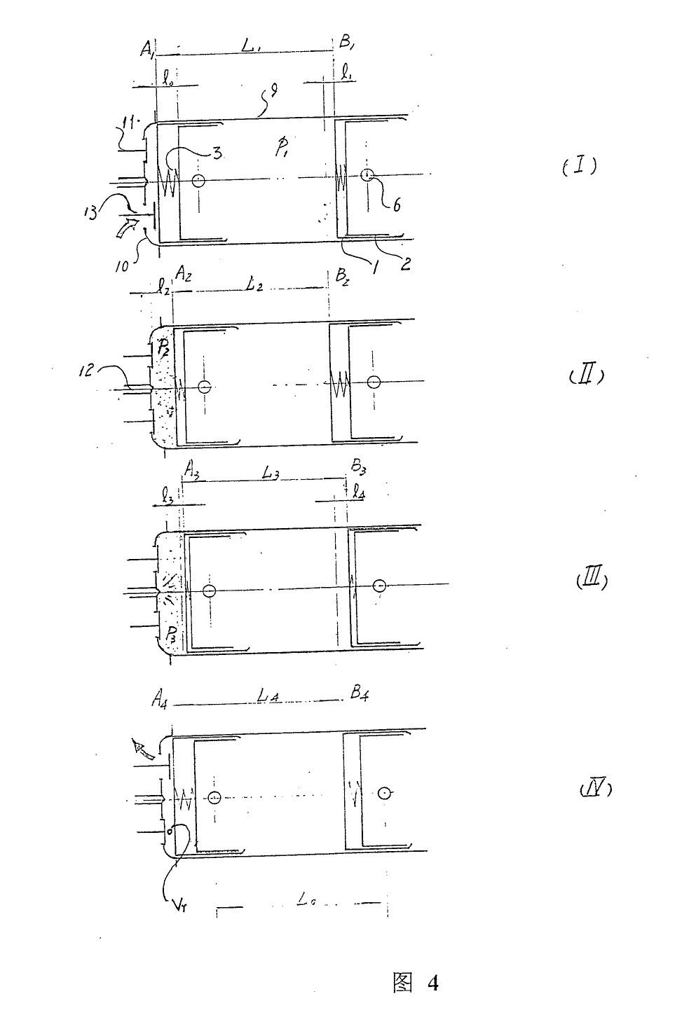

The most change of the engine in this invention is: The four strokes have different capacities, so that, the capacity-invariable is changed into variable-capacity engine (CVE). Although inner piston works still with the capacity-invariable engine behavior, as outer piston 1 is supported on the top of the inner piston 2 by the spring 3, the cylinder capacity and operating behavior change obviously during the four strokes. Please see FIG. 4:

Igniting the compressed air-fuel mixture under the required combustion temperature Tc and pressure Pc, means controlling a suitable compression ratio, the main points is to control the spring stiffness, so that the chamber volume (Vc) between the top of outer piston 101 and cylinder head 10 is on the design requirements of the compression ratio when engine is on the end of the compression stroke (II stroke). For example: select a compression ratio ε=10, on the end of compression the cylinder pressure Pc is about 1 MP, so outer piston moves down l₂ under the pressure Pc, then the combustion chamber volume Vc is about 1/10 of the total cylinder 9 volume. (in this invention, the total cylinder capacity V₀ is defined as the cylinder volume above the top of the outer piston 1, when the engine is on the bottom dead center of the compression stroke. Because inner piston 2 is on the point of the bottom dead center at the beginning of the stroke, so outer piston 1 is in free with the support of the spring 3 (Then the cylinder volume is same as the capacity-invariable engine).

Because the alternating pistons have motion inertia, the inertia force of outer piston 1 is different with different speed of the engine. When it is in slowly speed (such as idling), the piston inertia is small, so the vary of the compression space by the inertia force is small, the compression ratio ε is small too; In the high speed, outer piston inertia increases, the additional compression also increases, so the compression ratio is grown, the combustion conditions on high speed is improved. This is exactly the technical problems what the capacity-invariable engine efforts to resolve

In the exhaust stroke (stroke IV), exhaust valve 11 is opened, high pressure, high temperature waste gas flow outside rapidly, immediately piston shifts up realizing the enforcement drain, which same as the capacity-invariable engine. But in the end of exhaust stroke (A₄) (inner piston 2 is on top dead center), since the residual gas pressure (Pᵣ) is very low at this time (slightly bigger than 0.1 MP), the outer piston 1 will continue move under the function of the inertial and the spring (far away from the inner piston 2 in the axial direction), so residual vacancies (Vᵣ) reach the smallest space between the outer piston 1 and cylinder head 10. This indicates that the cylinder residue in the CVE at the end of the exhaust stroke is much less than that of the capacity-invariable engine.

At beginning of the intake stroke (stroke I), the intake valve 13 opens, the piston descends pulling by the crankshaft-connecting rod, with fresh mixture gas in taking. When the inner piston 2 move to bottom dead center B₁, outer piston 1 will continue downward l₁ compressing the spring 3 under the inertia force. So the addition volume caused by the inertia force of the outer piston 1, V₁=l₁*S,

(S-top surface area of outer piston, similar to the cross-sectional area of cylinder 9). While l₁ (V₁) is proportional to the engine speed: In low engine speed piston moves with a small velocity, that is the small inertia force of the outer piston, the l₁ (V₁) is small; In high engine speed, outer piston 1 has a great inertia force, and therefore l₁ (V₁) has also increased. That means, the intaking volume in high-speed is bigger than the one in low-speed, thereby it is a better compensation for intaking shortage at high speed. For example: The outer piston diameter D=8 cm, and mass m=1 kg, the working stroke L0=10 cm, compression ratio ε=10; When the engine speed n=3,000 rpm, you can calculate as follows: l₁≈l₂, that is V₁≈Vc.

It can be seen: CVE has high charging efficiency:

1) At the end of the exhaust stroke, outer piston 1 will shift up compressing the exhaust residual due to the inertia, this can make the exhausting efficiency reach to 95%˜98%, so the exhaust residues would be far below then one of the capacity-invariable engine.

2) At the end of the intake stroke, outer piston 1 shift downward l₁ due to the inertia. This can increase the intaking volume (V₁), so the intake capacity of the CVE is bigger than the same strokes capacity-invariable engine. It is observed that the charging efficiency η of the CVE is far larger than the 0.7˜0.8 amount of the one of capacity-invariable engine, that means the CVE has the ability of automatic supercharging.

As the high temperature waste gas reduces significantly, thus the temperature rise of the intaking fresh air-fuel mixture is reduced (temperature drops end of the intake stroke). For example: Give the exhaust efficiency 96%, that means the exhaust residue is about 1/25 of the total volumes of intaking gas. (While which is about one-tenth or greater for capacity-invariable engine), so heating form residue gas to fresh gas significantly reduced. It can be concluded by calculating that gas temperature will drop 30° K^{˜}50° K at the end of intake stroke, which may apply to improve the compression ratio ε. The compression ratio can be raised to 12 or higher without deflagrating, thereby enhancing the efficiency of the engine. And because of the decrease in amount of waste gas, combustion conditions improve, thereby increasing the output power, torque, making a very good engine power, fuel economy and better emissions performance of this CVE.

At the beginning of the compression stroke (stroke II), as the pressure in the cylinder is about 0.1 MP, outer piston 1 goes to free position on the force of the spring 3, on the location B₂ of the beginning of the compression stroke. Then intake valve 13 and exhaust valve are closed. With inner piston 2 ascending, outer piston 1 presses the air-fuel mixture gradually, so the cylinder pressure P rises accordingly. At this time, outer piston 1 presses spring 3 gradually under the pressure. When inner piston 2 moving to top dead center A2, the pressure P of the compressed mixture rises to the initial combustion conditions (Pc, Tc) as a request of the engine. Under this pressure Pc, outer piston 1 shifts downward l₂ pressing spring 3, so forming necessary combustion volume Vc (Design of spring stiffness that must accord with the above request). But the combustion volume Vc for the CVE at the end of the compression stroke is not a constant value.

Except above-mentioned condition, Vc also accepts by the inertia of the outer piston 1. Outer piston 1 inertial force is big in high speed, the compresses amounts by inertia also enhances, that means the combustion volume Vc is to have a diminution, with compression ratio improved. On the contrary, outer piston 1 has a small inertial force in low speed, the volume Vc general has a little enhancing, so the compression ratio decreases. But it exactly meets the need that the compression ratio changes when the engine in high speed or low speed, So the CVE has the function of automatic changing for compression ratio.

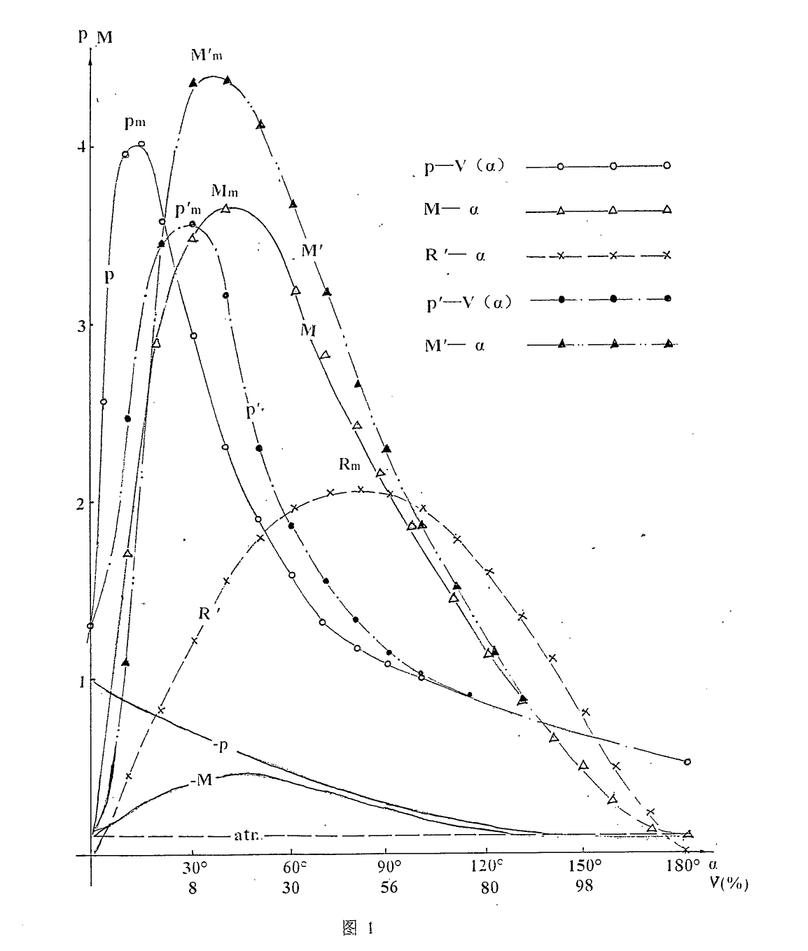

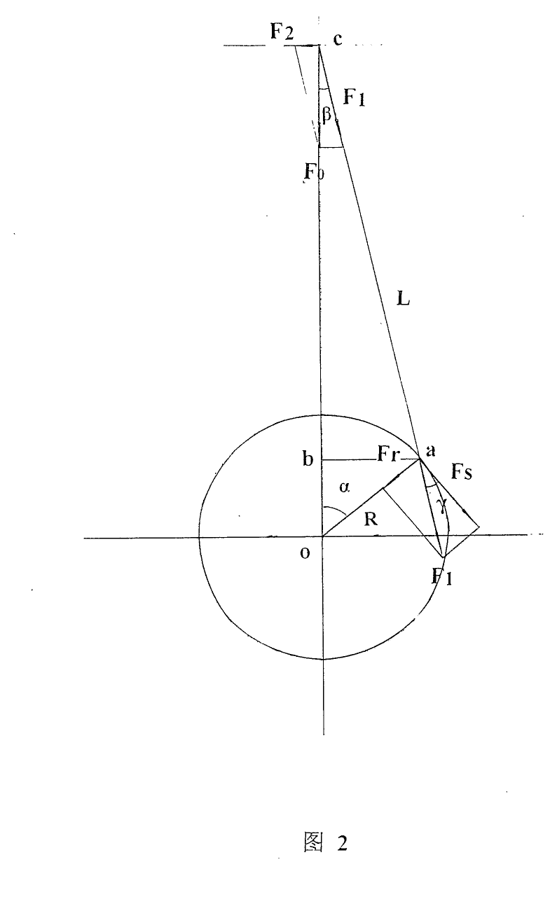

At the power stroke (stroke III), since the compression ratio is in a specified range, so the request of igniting the mixture gas is same as the one of capacity-invariable engine. As the CVE has higher charging efficiency and lower residual gas ratio, the combustion conditions is better. With the cylinder pressure P₃ rise rapidly, the outer piston shifts downward compressing spring 3 (see FIG. 3), thereby increases the combustion chamber space, slows the firing rate and reduce the speed of the pressure increasing. So the peak pressure Pm and peak temperature Tm low slightly, with peak pressure Pm of the CVE moving to the right, (Seeing the P′-V′ curve in FIG. 1). As the engine output power is proportional to the revolve n and torque M, and M is proportion to the gas pressure P and crankshaft effective radius R′, now the peak pressure Pm shifts to the right (P′-V′ curve shifted to the right), the angle of α corresponding to the Pm increases, so R′ increases marked, which makes the engine output torque M increased. In the same speed, the larger output torques the greater output power of the CVE. Shown as the torque-angle curve (M′-α) (This change can be explained from the energy conservation principle). It proved that the CVE has a better engine volumetric efficiency. Moreover, since the cylinder pressure P rises down and peak pressure Pm lowers, the force distributing of the engine assembly (piston, connecting rod, bearings, crankshaft, body, etc.) have a large improvement, which can make the structural components more lighter, thereby reduced the engine weight. It is useful to reduce fuel consumption for a vehicle and make the engine operation smoother and the lifetime longer.

In order not to make combustion conditions change excessively, the displacement l₃ of the outer piston 1 under the force of P₃ cannot be too large, then it is demands that spring 3 has a high stiffness (In the compression stroke, when the displacement is l₂ under the force of P₂, the spring has a lower stiffness). So a variable stiffness of spring 3 is used in this invention (such as cluster spring, cone spring or distance changed spring).

We can see that the poor working conditions (high temperatures, high pressure and high-speed transmission of power) of a single piston shared by inner and outer piston, Outer piston 1 only withstands high temperatures, high-pressure gas and ensures sealed with cylinder. However, the cylinder pressure is passed to inner piston 2 from outer piston 1 through spring 3, and passed to piston pin 6-connecting rod 4-crank arm 8 and then turns into the power output for the engine. Although the structure and stressing of the inner piston 2 are similar with the single-piston (capacity-invariable) engine, the inner piston 2 does not withstand high temperature basically (especially with enforcement oil cooling), and does not take in the cylinder seals, So thermal deformation for the piston is small. Also it is easy to select a reasonable basic structure reducing the stress and deformation, thus the working conditions are improved greatly for the complex structure of inner piston. The exterior circular face of the normal piston must be processed, big-end-down cone or other complex shapes for capacity-invariable engine, so that it is difficult to process and a shorter life for the piston. This problem is almost non-existent in double-engine piston structure. Outer piston 1 can use simple cylindrical structure, so it is easily processed. In addition, the side pressure is existed alternating during the piston reciprocating movement of the compression stroke and power stroke; it will make the outer piston spinning and the wearing evenly, so extend the life of piston effectively. While part wear is inevitable for the piston of the capacity-invariable engine.

We will further discuss the function parameters and the relationship between structural characteristics:

It can be seen from FIG. 3 the largest axial gap between outer piston 1 and inner piston 2 is l₀. In order to make the exhaust gas can emit as much at the end of the exhaust stroke, the tip surface 101 of outer piston should seat on the highest levels of the cylinder (because the gas pressure inside the cylinder is equivalent to atmospheric pressure at the end of exhaust stroke, The largest gap between outer piston 1 and the top 21 of the inner piston, under the force of spring 3 is l₀). In the end compression must adjust the space to presetting compression ratio (ε). The cylinder pressure is Pc at this time, the gas pressure applying on the outer piston 2 is:

Fc=Pc*S (S—Top surface area of the outer piston)

l₂=Fc/K₂=Pc*S/K₂ (K₂—stiffness for this piece of spring 3)

That is make the space between the top surface 101 of outer piston and cylinder head 10 meet the capacity requests for the combustion chamber at the presetting compression ratio ε. For example: give compression ratio to ε, ε=Vc/V₀

(V₀—The total cylinder capacity is defined as the cylinder volume above the top of the outer piston 1, when the engine is on the bottom dead center of the compression stroke). Assuming the stiffness of this piece spring 3 is K₂, we can calculate out:

K₂=ε(S*Pc/V₀)

As before said, slow down combustion speed appropriate to reduce the peak value pressure Pm and slow down the pressure P accessional velocity, it is request for the outer piston descending l₃ on the pressure of P₃, so that it can extend the firing space appropriate. Since Pm [symbol] Pc, in order not to change the combustion conditions excessively to affect the normal combustion process, the value of l₃ must be controlled. Generally, l₃≦l₂, then the stiffness of spring 3 is: K₃ [symbol] K₂ (as Pm [symbol] Pc)

From structure, this indicates spring 3 must have changeable stiffness. For example helical spring and mutilate disk springs are suited to meet the above request. as shown in FIG. 8(I), Also can use cone spring, various-distance spring, as shown in FIG. 8 (II, III).

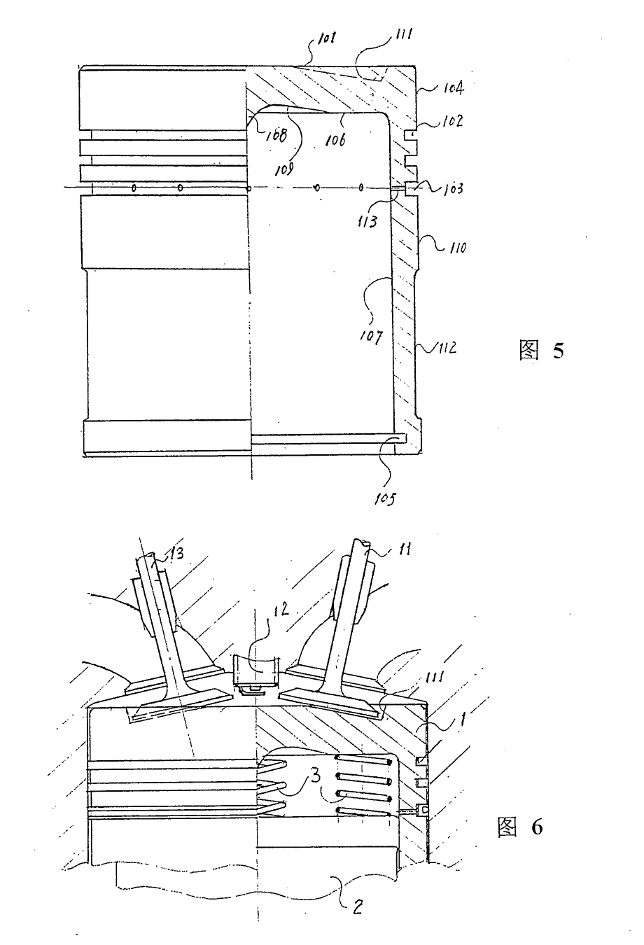

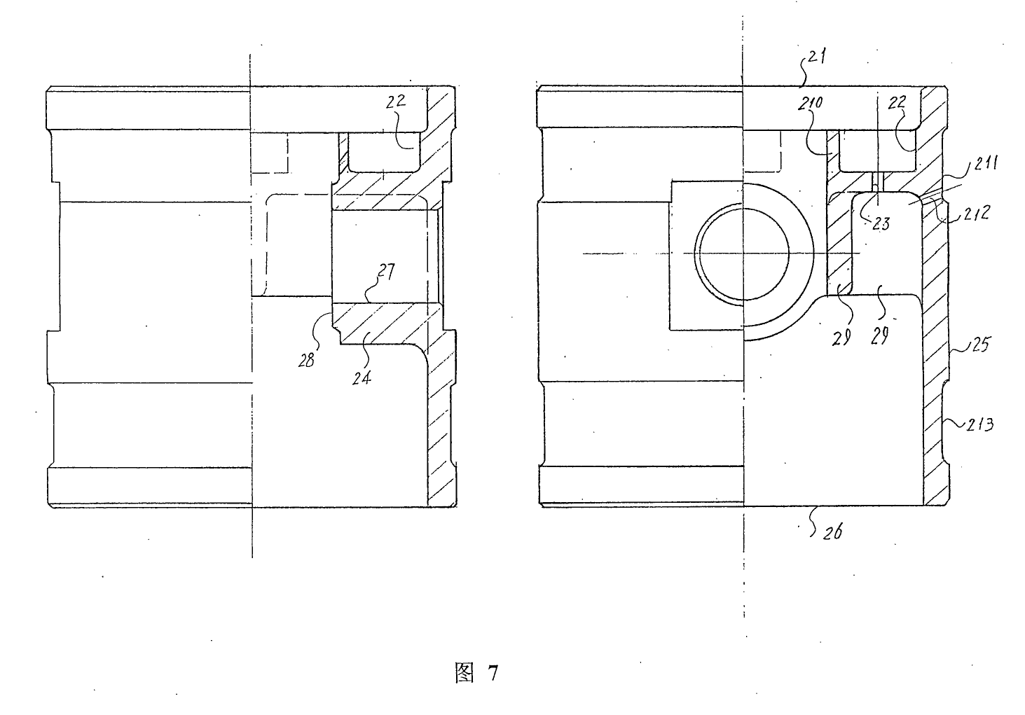

FIG. 5 is a structural schematic diagram of outer piston 1. Since there being no piston pin holes, the distance between the gas ring groove 102 and the top surface 106 is able to be more distant. This could be reduce the leak capacity passing piston ring notch and hot deformation amounts. The diameter of head 104 (parts above gas ring groove 102) is smaller than the skirt diameter, which compensates the deformation by the high temperature. The top surface 101 shape is determined by the cylinder head designing (combustion chamber structure, air valve arrangement, sparking plug location etc.), FIG. 6 is showing a kind of hemispheric combustion chamber placing a sparking plug in the middle of the cylinder head and inclining symmetric valves. Be to exhaust the waste gas as far as possible, outer piston 1 is much close to the cylinder head at the end of the exhausting. To avoid the air valve touch the top surface 101 of outer piston, dig some avoid-value pockets 111 same number of the valves, as shown in FIG. 6.

Bridging cone 108 and flow-guiding cambered surface 109 for the cooling oil in the center of the top interior surface 106 of the outer piston, can make the oil from the small end of connecting rod 43 cooling the 106 surface of the outer piston 1 better, preventing the 101 temperature highly raised. To improve the performance of the cooling, the surface 106 can be sandblasted keeping the surface rough. The plane of inside surface 106 contacts to the spring 3 should be level to touch well with the top of spring 3. A slot 105 is on the bottom of the inner hole 107 of outer piston, using for installed the elastic retainer ring to prevent the inner piston 2 from the inner hole 107. It can be seen the piston pin do not connect the outer piston 1, so outer piston 1 can be made into the homogeneous axial symmetry structure. This avoids the uneven heat deformation because of mass distribution. Then the exterior surface 104 and 109 do not need to elliptically, so it changes easy to process outer piston lowering down the cost notably. Also as there is no uneven heat deformation, the working conditions of outer piston manage to improve. Not only helping improve cylinder running conditions, also helping lighten wear, prolong the life time of the piston and the cylinder liner. To lighten weight and to avoid fine machining, we can reduce the diameter center of the outer piston skirt 109.

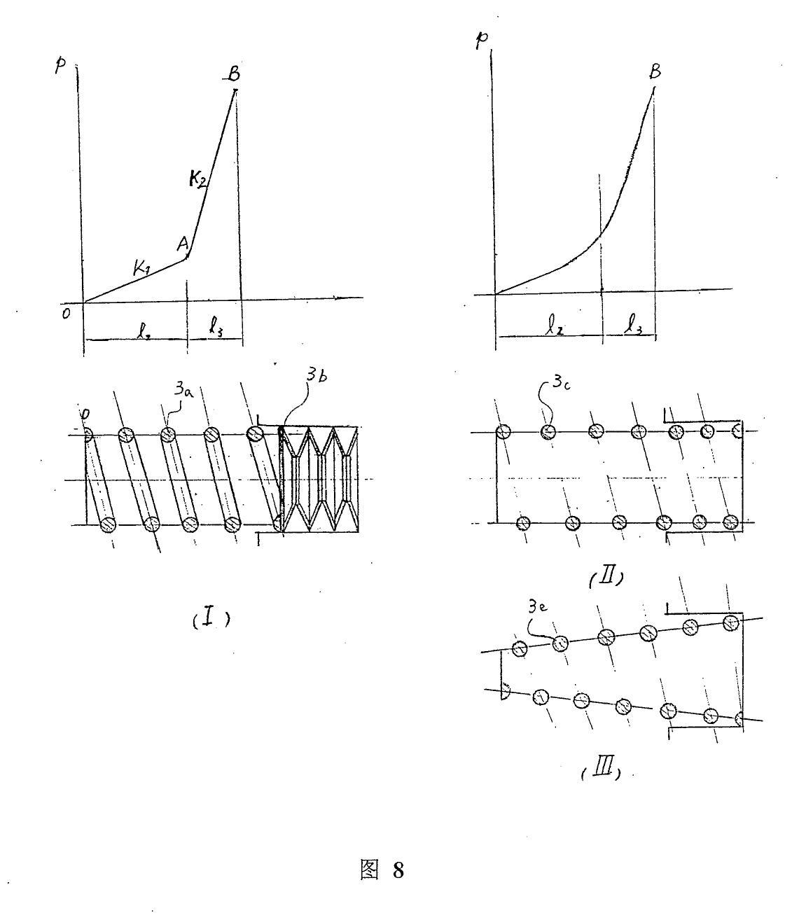

FIG. 7 is a structure schematic diagram of inner piston 2. One big different of inner piston 2 from generic pistons is, inner piston 2 uses an axial open type structure. Inner piston 2 does not touch the high temperature, high pressure gases, so design and manufacture for inner piston 2 are feasible. Adding the feather advance ribs 29, makes inner piston 2's radial rigidity get great advance. It is helpful to reduce the uneven deformation caused by lateral pressure during driving. While inner piston 2 is far away from the high temperature gas, also with enforced lubrication cooling, deformation is also diminishing. Thereby exterior circular surface 25 of inner piston 2 does not process to be elliptically yet, which not only simplifies the process also improves the quality of fit between the inner and outer piston. Flute 22 is used for installing spring 3, with a hole 23 on the bottom or side. The hole 23 is oil back-flow passage for the inside surface of the outer piston 1. Since the inner piston temperature raise less, the diameter of the pin hole 27 on the pin seat 23 is smaller than the exterior diameter of the piston 6, the piston pin 6 pressed closely in the pin hole 27, so inner piston's life can be prolonged effectively. Withdraws neck 211 on the surface is to collect the oil from oil-ring groove 103 of outside piston 1, and the oil return to the tank after the hole 212. Lower withdraw neck is to avoid fine machining face and to improve quality of fit between the inner and outer piston.

Above all, the CVE's double-pistons assemblies has great differences on structure from capacity-invariable engines piston, whose structure and fabrication properties improve greatly. It can be seen CVE have more benefits as follow:

1. Cut down waste residual amounts, increase air intake, lower down the waste residual ratio greatly, and so increase charging efficiency notable, improve the engine combustion situation, also improve compression ratio ε to 12 or higher, engine efficiency have been advanced thereby, fuel efficiency and exhaust emissions get improvement equally.

2. Since intake stroke has pressurization, in addition effective output torque increases, power-to-volume ratio have improved as a result. With same power output, the engine weight has been lightened and oil consumption has reduced further.

3. Since engine structure force is improved during the power stroke, the structure dimension of inner piston, piston pin, connecting rod, bearing, crankshaft, housing body can be diminished, which lightweights the engine and cut down the entire vehicle oil consumptions further.

4. Since elasticity piston system has the effect damping and absorbing, the burning gas pressure in cylinder rises could not too quickly, which makes the engine work smoothly and engine working condition further improve.

5. Since the inner, outside piston running conditions have great improvement, the structures are easy to manufacture, thereby, the cost of manufacture have reduced and the life have prolonged.

### INDUSTRY APPLICATION

This present invention CVE has two pistons interlinked mutually in every cylinder. Inner piston connects with the piston pin by the connecting rod, outer piston with a ring sits on inner piston supported by the spring. The characteristic of this engine is: Every stroke volume changes diversity. In exhaust stroke, outer piston gets to the tiptop of the cylinder, exhaust gas almost discharges (exhaust ratio can be to 95%˜98% in theory), compression ratio is improved (≧12); In intake stroke, outer piston continues moving by the inertia at the end of the intake stroke, the gas intake volume increases. So it realizes the automatic supercharging and the fuel efficiency and emission have improved. Since outer piston has the effect of storing energy, the peak pressure and the speed of the pressure raising have been reduced. Thereby, the force on the structure is lower down and the engine weight is lightened, the smoothness of operation is also improved. Also the peak pressure shifts to right, the torque output increases and engine efficiency is improved.

Comparing with capacity-invariable engine, This present CVE has great changes and improvements on fundamental and structural and worth to study and extend further more.

1. A positive-displacement engine is composed of cylinder, cylinder head and with intake-exhaust system, sparking plug, piston, connecting rod, crank-shaft etc. Whose characteristic is: its piston includes outer piston and inner piston, with a piston ring on outer piston and a pin hole with matched connecting rod on inner piston. The interior hole diameter of outer piston is greater than inner piston exterior diameter a little. Outer piston top interior surface is supported on inner piston with elastic components.

2. The positive-displacement engine according to claim 1, wherein the ring groove is cutting on the bottom of the inner bore for outer piston, with elastic retainer ring in it. The retainer interior diameter is smaller than the inner piston exterior diameter.

3. The positive-displacement engine according to claim 1, wherein the elastic component can be one or more helical spring, disk spring, conical spring, unequal spur spring etc or their combinations. And also it can be spring sets with more than two springs.

4. The positive-displacement engine according to claim 1, wherein the outer piston has symmetrical structure of radial direction, a bridging core with protuberances is on its top central wall and a flow-guiding cambered surface adjacent.

5. The positive-displacement engine according to claim 1, wherein the inner piston top surface is not to seal off, there are some ribs connected the side of the two pin holes' seat, also between the side face and the inner face of the inner piston, There are ribs support inner hole of inner piston. The pin hole diameter of inner piston is smaller than the diameter of the pin.

6. The positive-displacement engine according to claim 5, wherein the an oil groove is cut on the encircle face of inner piston, with a oil gallery connected with the inner bore in the bottom of the groove.

7. The positive-displacement engine according to claim 1, wherein the a locating hole is on the top of the inner piston, with a return port oil-returning hole for oil on the bottom or side face of the locating hole.
